(19) United States
(12) Patent Application Publication
(10) Pub. No.: US 2023/0024597 A1
(43) Pub. Date: Jan. 26, 2023

(54) SYSTEMS AND METHODS FOR PHASE UNWRAPPING

(71) Applicant: Analog Devices, Inc., Wilmington, MA (US)

(72) Inventor: Charles MATHY, Arlington, MA (US)

(73) Assignee: Analog Devices, Inc., Wilmington, MA (US)

(21) Appl. No.: 17/945,900

(22) Filed: Sep. 15, 2022

Related U.S. Application Data
(63) Continuation of application No. PCT/US2021/022687, filed on Mar. 17, 2021.
(60) Provisional application No. 62/991,484, filed on Mar. 18, 2020.

(51) Int. Cl. G01S 17/894; G01S 7/4915; G01S 17/36

(52) U.S. Cl. CPC G01S 17/894; G01S 7/4915; G01S 17/36

(57) ABSTRACT

Systems and methods are disclosed for phase unwrapping for time-of-flight imaging. A method is provided for phase unwrapping that includes measuring a plurality of wrapped depths at a respective plurality of frequencies, wherein each of the plurality of wrapped depths corresponds to a respective phase, generating a plurality of unwrapped phases based on a probability distribution function, by unwrapping each of the plurality of wrapped depths, and identifying a Voronoi cell.

### CROSS-REFERENCE TO RELATED APPLICATIONS

This application claims the benefit of and hereby incorporates by reference, for all purposes, the entirety of the contents of International Patent Application No. PCT/US2021/022687, filed Mar. 17, 2021, and entitled, “SYSTEMS AND METHODS FOR PHASE UNWRAPPING,” and to U.S. Provisional Patent Application No. 62/991,484 entitled, “SYSTEMS AND METHODS FOR PHASE UNWRAPPING” filed on Mar. 18, 2020.

### FIELD OF THE DISCLOSURE

The present disclosure relates to phase unwrapping. More specifically, the disclosure relates to phase unwrapping in time-of-flight imaging.

### BACKGROUND

Time of flight (ToF) is a property of an object, particle or acoustic, electromagnetic or other wave. It is the time that such an object needs to travel a distance through a medium. The measurement of this time (i.e. the time of flight) can be used as a way to measure velocity or path length through a given medium, or as a way to learn about the particle or medium (such as composition or flow rate). The traveling object may be detected directly (e.g., ion detector in mass spectrometry) or indirectly (e.g., light scattered from an object in laser doppler velocimetry).

The Time-of-Flight principle (ToF) is a method for measuring the distance between a sensor and an object based on the time difference between the emission of a signal and its return to the sensor after being reflected by an object. Various types of signals (also called carriers) can be used with ToF, the most common being sound and light. Some sensors use light as their carrier because it is uniquely able to combine speed, range, low weight and eye-safety. Infrared light can ensure less signal disturbance and easier distinction from natural ambient light resulting in the higher performing sensors for a given size and weight.

A time-of-flight camera (ToF camera) is a range imaging camera system that resolves distance based on the known speed of light, measuring the time-of-flight of a light signal between the camera and the subject for each point of the image.

In time-of-flight (TOF) image sensors, the image sensor captures a two-dimensional image, or several two-dimensional images, from which a processor can determine the distance to objects in the scene. The TOF image sensor is further equipped with a light source that illuminates objects whose distances from the device are to be measured by detecting the time it takes the emitted light to return to the image sensor. The system may also utilize image processing techniques.

A depth camera is a camera where each pixel outputs the distance between the camera and the scene. One technique to measure depth is to calculate the time it takes for the light to travel from a light source on the camera to a reflective surface and back to the camera. The time travelled is proportional to the distance to objects. This travel time is commonly referred as time of flight.

Continuous-wave time-of-flight (CW-TOF) cameras obtain distance measurements which wrap at a distance inversely proportional to the frequency of operation. In particular, cameras measure the phase difference between an emitted periodic laser signal and its reflection, and the phase difference is used to determine how far the light has travelled. To obtain accurate and unambiguous distance measurements, it can be advantageous to measure the distance at a set of frequencies and use the different measurements to unwrap the distance. However, modern CW-ToF imaging may have upwards of millions of pixels. Therefore, the amount of compute time per pixel is relatively limited, and having fast unwrapping schemes is necessary to ensure real-time performance, for example 30 frames per second.

This disclosure is intended to provide an overview of subject matter of the present patent application. It is not intended to provide an exclusive or exhaustive explanation of the invention. Further limitations and disadvantages of conventional and traditional approaches will become apparent to one of skill in the art, through comparison of such systems with some aspects of the present invention as set forth in the remainder of the present application with reference to the drawings.

### SUMMARY OF THE DISCLOSURE

Aspects of the embodiments are directed to phase unwrapping systems, methods and devices for time-of-flight imaging. In particular, systems and methods are presented herein for fast and simultaneously accurate unwrapping methods.

According to one aspect, a system for phase unwrapping includes a transmitter configured to transmit a plurality of frequencies, wherein the plurality of frequencies include a first frequency at seventeen times the base frequency, a second frequency at nineteen times the base frequency, and a third frequency at twenty-two times the base frequency; a receiver configured to receive a plurality of reflected frequencies corresponding to the plurality of frequencies; and a processor configured to determine a plurality of wrapped distance measurements at the plurality of frequencies and determine a lattice of Voronoi cells wherein each Voronoi cell corresponds to a respective wrapped distance measurement.

According to one aspect, a method for phase unwrapping in time-of-flight systems comprises determining a plurality of wrapped distance measurements at a respective plurality of frequencies, wherein each of the plurality of wrapped distance measurements corresponds to a respective phase; generating a plurality of unwrapped depths for each of the plurality of wrapped distance measurements, based on the respective phase; measuring a plurality of Voronoi vectors corresponding to the plurality of unwrapped depths; and determining a lattice of Voronoi cells, wherein each of the plurality of unwrapped depths corresponds to a respective Voronoi cell of the lattice.

According to some implementations, the method includes estimating a distance to an object, and identifying a corresponding Voronoi cell of the lattice for the estimated distance. According to some examples, identifying the corresponding Voronoi cell includes using a lookup table to map the estimated distance to the corresponding Voronoi cell. In some examples, the method includes applying a transformation to the estimated distance using a plurality of vectors.

According to some implementations, the method includes generating a plurality of projected line segment points wherein each of the plurality of projected line segment points corresponds with a respective one of the plurality of unwrapped depths. In some examples, determining the lattice of Voronoi cells includes determining an area around each of the plurality of projected line segment points corresponding with the respective projected line segment point based on the plurality of Voronoi vectors.

According to some implementations, each of the plurality of frequencies is a multiple of a base frequency. In some examples, the plurality of frequencies includes a first frequency at seventeen times the base frequency, a second frequency at nineteen times the base frequency, and a third frequency at twenty-two times the base frequency.

According to another aspect, a system for phase-unwrapping comprises a receiver configured to receive reflected frequencies and a processor. The processor is configured to determine a plurality of wrapped distance measurements at a respective plurality of frequencies, wherein each of the plurality of wrapped distance measurements corresponds to a respective phase, generate a plurality of projected line segment points based on the plurality of wrapped distance measurements, and determine a lattice of Voronoi cells, wherein each Voronoi cell corresponds to one of the plurality of projected line segment points.

According to some implementations, the processor is further configured to measure a plurality of Voronoi vectors, and wherein an area for each Voronoi cell of the lattice is determined based on Voronoi vectors. According to some examples, the processor is further configured to measure a distance to an object and identify a corresponding Voronoi cell of the lattice for the measured distance. In some examples, the processor is further configured to measure the distance based on the received reflected frequencies.

According to some implementations, the processor is further configured to generating a plurality of unwrapped depths for each of the plurality of wrapped distance measurements, based on the respective phase, and each of the plurality of projected line segment points corresponds with a respective one of the plurality of unwrapped depths.

According to some implementations, the system further includes an emitter configured to emit a plurality of frequencies and wherein at least a portion of the plurality of frequencies reflected and received at the receiver. In some examples, each of the plurality of frequencies emitted by the emitter is a multiple of a base frequency. In some examples, the plurality of frequencies emitted by the emitter includes a first frequency at seventeen times the base frequency, a second frequency at nineteen times the base frequency, and a third frequency at twenty-two times the base frequency.

According to another aspect, a method for phase unwrapping in time-of-flight systems includes estimating a distance to an object and generating a corresponding measurement point; applying a transformation to the measurement point using a plurality of vectors; matching the measurement point to a Voronoi cell for a wrapped distance measurement based on the transformation, wherein the wrapped distance measurement is a projected line segment point; and determining an unwrapped depth based on the projected line segment point.

According to some implementations, applying the transformation includes using Voronoi vectors to identify the Voronoi cell. According to some examples, the measurement point is at most one Voronoi vector away from the projected line segment point. In some examples, the measurement point includes a first measurement at a first frequency, a second measurement at a second frequency, and a third measurement at a third frequency.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

For a fuller understanding of the nature and advantages of the present invention, reference is made to the following detailed description of preferred embodiments and in connection with the accompanying drawings, in which:

FIG. 1A shows noiseless phase measurements, in accordance with one or more embodiments of the disclosure provided herein;

FIG. 1B shows projected phase measurements for the example in FIG. 1A, in accordance with one or more embodiments of the disclosure provided herein;

FIG. 1C shows a transformation of the projected phase measurements for the example in FIG. 1A to be a subset of a square lattice, in accordance with one or more embodiments of the disclosure provided herein;

FIG. 2 shows the entities involved in fast accurate phase unwrapping, in accordance with one or more embodiments of the disclosure provided herein;

FIGS. 3A-3C are diagrams showing lattices for phase unwrapping, in accordance with one or more embodiments of the disclosure provided herein;

FIG. 4 shows a diagram identifying a projected line segment associated with a measurement point, in accordance with one or more embodiments of the disclosure provided herein;

FIG. 5 shows an imaging device, in accordance with one or more embodiments of the disclosure provided herein;

FIG. 6 illustrates an example of system incorporating an imaging device of the type described herein

FIG. 7 illustrates a mobile device incorporating an imaging device of the types described herein;

FIG. 8 illustrates a gaming console incorporating an imaging device of the types described herein; and

FIG. 9 illustrates a robot incorporating an imaging device of the types described herein.

### DETAILED DESCRIPTION

The present disclosure relates to systems, methods and devices for phase unwrapping in time-of-flight imaging. Continuous-wave time-of-flight (CW-TOF) cameras obtain distance measurements which wrap at a distance inversely proportional to the frequency of operation. To obtain accurate measurements, the distance at a set of different frequencies is measured, and the different measurements are used to unwrap the distance. Modern CW-ToF imaging can have upwards of millions of pixels, and the amount of compute time per pixel is relatively limited. Thus, having fast unwrapping schemes is necessary to ensure real-time performance, for example 30 frames per second. However, current techniques to obtain fast unwrapping impact the accuracy of the unwrapping results, leading to unwanted unwrap errors. Systems and methods are presented herein for fast and accurate unwrapping methods.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Phase Unwrapping

Imaging systems obtain distance measurements which wrap at selected distances based on the frequency of the reflected signal. To obtain accurate time-of-flight measurements, the distance at a set of different frequencies is measured, and the different measurements are used to unwrap the distance. In some examples, a time-of-flight imager estimates a set of wrapped distances at M frequencies:

f₁,f₂, . . . ,f_{M}

where M is the number of frequency measurements. The M frequencies can be combined into a vector:

f=(f₁,f₂, . . . ,f_{M})=mf₀

where f₀ is the base frequency, and the notation m is introduced for the vector of frequency ratios. A depth Dᵢ is associated with each frequency fᵢ as follows:

$${D}_{1} = \frac{c}{2 {f}_{1}} , {D}_{2} = \frac{c}{2 {f}_{2}} , … , {D}_{M} = \frac{c}{2 {f}_{M}}$$

Each frequency fᵢ is used to calculate a wrapped depth:

d₁(mod D₁),d₂(mod D₂), . . . ,d_{M}(mod D_{M})

In some examples, harmonic cancellation is performed on the depth measurements to ensure that the depth measurements depend linearly on distance.

Each depth can be associated to a phase between 0 and 1. That is, the depth phases are like regular phases but divided by 2π:

$${ϕ}_{1} = \frac{{d}_{1}}{{D}_{1}} ( mod 1 ) , {ϕ}_{2} = \frac{{d}_{2}}{{D}_{2}} ( mod 1 ) , … , {ϕ}_{M} = \frac{{d}_{M}}{{D}_{M}} ( mod 1 )$$

Once the phase measurements are obtained, the phase measurements are unwrapped. In particular, the unwrapped distance is determined for each frequency. Unwrapping the phase measurements involves determining the integer:

i₁,i₂, . . . , c

such that

d₁=(ϕ₁+i₁)D₁,d₂=(ϕ₂+i₂)D₁, . . . , d_{M}=(ϕ_{M}+i_{M})D_{M}

where d₁, d₂, . . . , d_{M} are unwrapped depths. If there were no noise sources then all the distances dᵢ at a given pixel would be equal to the distance to the object at said pixel. However, in real world measurements, there may be some differences between the estimated unwrapped depths. If the unwrapping integers were estimated incorrectly, then the differences between some of the unwrapped depths dᵢ can be very large. Incorrect estimation of unwrapping integers is called an unwrapping error, and it can lead to catastrophically large estimation errors. In some examples, a system is able to catch an unwrapping error. For instance, if it is determined that the differences between the unwrapping depths dᵢ is too large to be explained by noise, according to a noise model, a system may flag an unwrapping error. In some examples, the system may report that the depth cannot be estimated for the pixel corresponding to the unwrapping error. In use cases, such as a time-of-flight camera mounted on a robot to estimate distances from nearby humans, where it is critical to obtain fast and reliable distance estimates, reducing the occurrences of unwrap errors below some safe probability can be of paramount importance.

A final depth measurement is determined by combining the unwrapped depths. For example, the unwrapped depths d₁, d₂, . . . , d_{M} can be combined using inverse variance weighting given an estimate of the variance of each measurement, to obtain a final depth measurement:

$$d = \frac{{\sum }_{i} \frac{{d}_{i}}{{σ}_{i}^{2}}}{{\sum }_{i} \frac{1}{{σ}_{i}^{2}}}$$

where σᵢ is an estimate of the standard deviation of each depth measurement. In some examples, a model for the standard deviation depends on parameters such as dark current, an estimate of shot noise, and thermal noise, and these parameters can be included in the formula to calculate the standard deviation.

In some implementations, the imager also estimates the amplitude of the return signal. The amplitude of the return signal can be included as a parameter to estimate the standard deviation of the distance measurement. In some examples, a time-of-flight imager emits a periodic signal of light which travels to the scene and returns to the sensor. The periodic signal of light has an amplitude that depends on the reflectivity of objects in the scene and a time delay proportional to the distance to objects in the scene. The sensor can estimate the amplitude and time delay of the return signal. In some examples, the sensor estimates the amplitude and time delay of the return signal by performing correlation measurements of the return signal with finite number of phase delayed emitted signals. The estimation can be performed at each frequency, and the estimated distances dᵢ are then proportional to the time delays. Since the emitted and correlation signals are periodic, the obtained estimated distances dᵢ may wrap at a distance

$${D}_{i} = \frac{c}{2 {f}_{i}} .$$

To understand how to unwrap, points can be plotted in the space of phases. For example, ϕ=(ϕ₁, ϕ₂, . . . , ϕ_{M}), a vector in M-dimensional space. As a function of depth d, the (noiseless) phase vector is:

$$ϕ = \frac{2 d}{c} f ( mod 1 ) = \frac{2 {df}_{0}}{c} m ( mod 1 )$$

where (mod 1) is applied to the components of the vector.

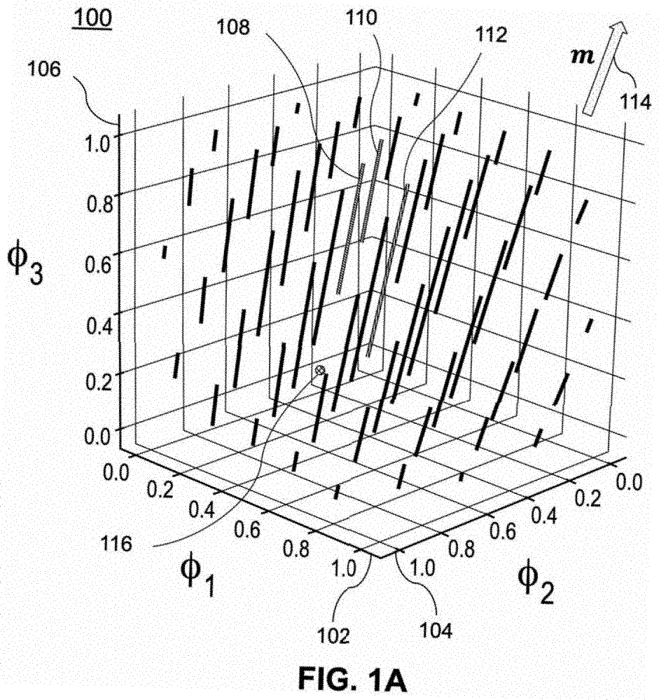

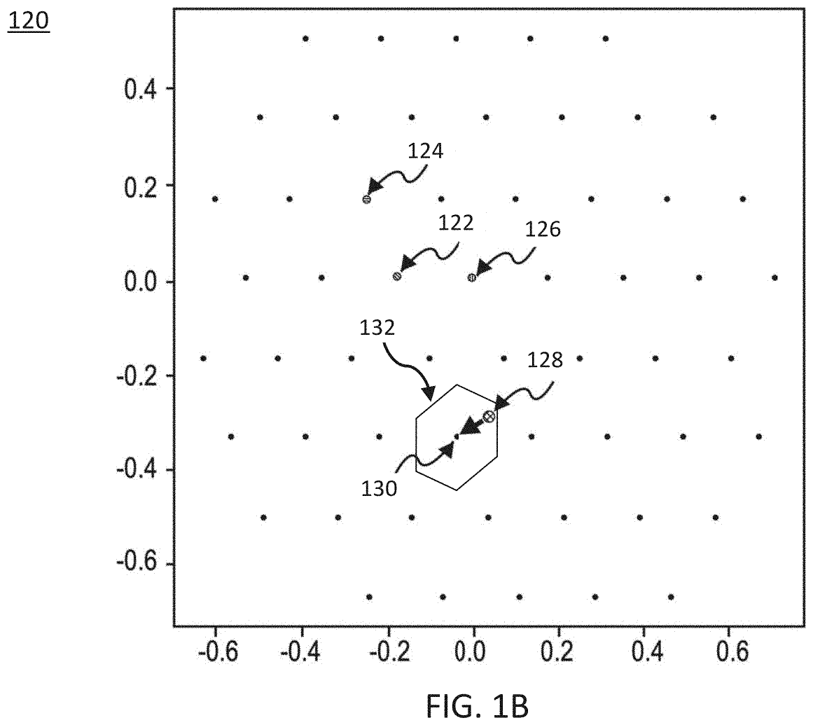

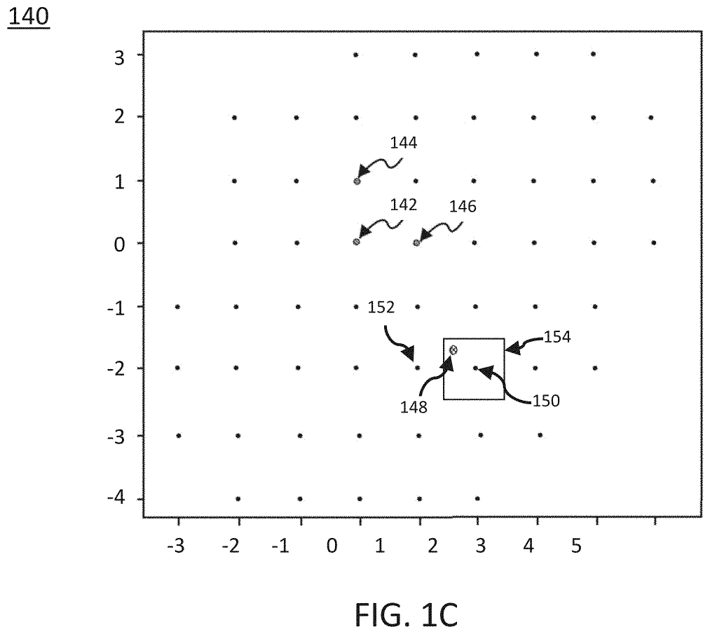

FIG. 1A shows a 3-dimensional diagram of wrapped distance measurements at three frequencies, according to various embodiments of the disclosure. In particular, the diagram includes a first axis showing a first phase ϕᵢ, a second axis 104 showing a second phase ϕ₂, and a third axis 106 showing a third phase ϕ₃. The line segments in diagram show noiseless phase measurements obtained for three frequencies, drawn in the 3-dimensional phase space, according to various embodiments of the disclosure. The line segments are parallel to the vector m 114. The beginning and end of line segments occur every time one of the phases is either 0 or 1 and therefore wraps. Every time the line

$$\frac{2 {df}_{0}}{c} m$$

as a function of d has one of its entries equal to 1, that coordinate returns to 0 (that is, the phase wraps). Each line segment has associated with it a vector of unwrap integers. When a wrapping occurs, a new line segment is reached, which has its own set of unwrapping integers. Therefore, each line segment is associated with a set of unwrapping integers

i=(i₁,i₂, . . . , i_{M})

which can be precomputed and stored in a lookup table. The solitary point 116 is an example measurement, which does not sit on a line segment, for example because of noise. The task of unwrapping is to find the line segment that the measurement point 116 corresponds to. The unwrapping integers for the measurement point 116 are those associated with the appropriate line segment.

FIG. 1B is a diagram 140 which shows a projection of the line segments onto a (M−1)-dimensional space, according to various embodiments of the disclosure. In the exemplary embodiment of FIG. 1, the number of measurement frequencies equals three (M=3), and therefore the (M−1)-dimensional projection space is two-dimensional. A matrix P is defined which maps the M-dimensional phase vector ϕ onto an (M−1)-dimensional space. The matrix P takes all the points in each line segment obtained from noiseless measurement to one point per line segment. In some examples, the matrix P is a projection matrix, satisfying the property P²=P. In other examples, the matrix P is not a projection matrix in the mathematical sense. In some examples, since the line segments are parallel to the vector 114 m shown in FIG. 1A, mapping the points in each line segment to a single point through the application of the matrix P is equivalent to requiring that

P·m=0

The matrix P is applied to ϕ giving

v=P·ϕ

The projection of line segments perpendicularly to m can be precomputed. Each line segment becomes a point, giving a set {p₁, p₂, . . . , p_{N}} of (M−1)-dimensional points, where N is the number of line segments.

In real-world situations, measurements will include noise. As discussed above, the noise can include a combination of one or more of shot noise, dark current noise, noise due to background light, and other noise. Measurements including noise can result in measured points not corresponding with any one of the line segments. Thus, the measured ϕ will not sit exactly on one of the line segments of FIG. 1A. One approach to unwrapping is to find the line segment that the vector of measured phases ϕ most likely corresponds to.

A first line 108 from FIG. 1A projects onto point 122 in FIG. 1B. A second line 110 from FIG. 1A projects onto point 124 in FIG. 1B. A third line 112 from FIG. 1A projects onto point 126 in FIG. 1B. The example measurement point 116 in FIG. 1A projects to a point 128 in (M−1)-dimensional space in FIG. 1B. Associated with each projected line segment in FIG. 1B is an area inside of which all points are closer to the projected line segment than to any other projected line segment. The area associated with projected line segment 130 in FIG. 1B is bounded by a perimeter 132. Since the projected measurement point 128 is inside the area bounded by the perimeter 132, the point 128 is closer to the projected line segment 130 than to any other projected line segment represented by the points in FIG. 1B.

In some approximations, the noise model of the time-of-flight imager can be such that the maximum likelihood estimate of the correct unwrapping of a measurement is found at the projected line segment that is nearest to the projected measurement. In such an example, the projected line segment 130 from the projected measurement point 128 is identified and the associated unwrapping integers are found in a lookup table. In particular, the lookup table includes a set of most likely unwrapping integers associated with each projected line segment. In some examples, the noise model does not easily correspond to finding the nearest projected line segment, and the perimeter of the area for a projected line segment can have a different shape. In particular, the points for which the most likely projected unwrapping line segment is a given projected line segment can have a different shape. If the number of measurements M is greater than three, the areas around each projected line segment become (M−1)-dimensional volumes. In various examples, the term area refers to an (M−1)-dimensional volume.

In some implementations, the area associated with each projected line segment is computed offline and stored for use when the camera is in operation. Unwrapping then amounts to projecting a set of phase measurements and computing which area a projected point is in. If the unwrapping problem amounts to finding the nearest projected line segment, then one could resort to a brute-force approach of computing the distance between the projected point and all the projected line segments, and finding the projected line segment of closest distances. Such an approach may be computationally infeasible, as it has to be carried out independently for each pixel.

FIG. 1C illustrates an approach to a fast unwrapping paradigm. The exemplary projected space can be transformed with a linear (M−1)×(M−1) dimensional matrix to a space 140 in FIG. 1C where the set of projected line segments are a subset of the regular hypercubic lattice with the points having coordinates (x₁, . . . , x_{M-1}) where all the xᵢ are integers. Obtaining the nearest point to a point on such a lattice can be done in a very efficient way: given a projected measurement point (yᵢ, . . . , y_{M-1}), the nearest point in the hypercubic lattice is ([y₁], . . . , [y_{M-1}]), where [yᵢ] is the integer nearest to yᵢ. The projection from FIG. 1A to FIG. 1B can be represented as an (M−1)×M dimensional matrix. The transformation from FIG. 1A to FIG. 1C can be represented as a single (M−1)×M dimensional transformation matrix P.

The problem with a transformation that takes the line segments to a subset of a hypercubic lattice is that it may distort distances in the projected space. For example, in FIG. 1B the projected measurement point 128 was closest to the projected line segment 130. When transforming FIG. 1A instead to the space 140 in FIG. 1C, the measurement point 116 is mapped to point 148. The projected line segment 130 from FIG. 1B is equivalent to point 152 in FIG. 1C. However, the measurement point 148 is not closest to the projected line segment 152 in the space 140. Instead, the measurement point 148 is closest to a different projected line segment, which maps to point 150 in space the 140. Therefore, for the measurement point 148, the mapping to a space where the projected line segments form a subset of a hypercubic lattice results in an unwrapping error. As described earlier, unwrapping errors can lead to catastrophic distance estimation errors.

The number of unwrapping errors arising from mapping the line segments to a subset of a hypercubic lattice can increase as the number of measurement frequencies increases, since the distortions of the (M−1)-dimensional volumes associated with each projected line segment can become more severe. If the undistorted projected lattice undergoes little distortion to be mapped to a subset of a hypercubic lattice, then the approach of FIG. 1C may suffice. However, there are examples of sets of frequencies where the projected line segments undergo an amount of distortion that impacts performance. For example, the usable range of a time of flight camera may be limited by the ability to correctly unwrap measurements. Once the unwrapping error probability crosses a certain threshold, the depth measurements can no longer be considered reliable. For example, for a vector of ratios of frequencies m={17, 19, 22} the projected line segments form a lattice that suffers severe distortion when mapped to a subset of a square lattice. But, a vector m with integer entries relatively close to each other can have certain benefits. For example, the errors for higher frequency measurements are typically less noisy since the error in depth estimate can scale inversely with frequency. Therefore, for vectors m that are close to each, the frequencies can be selected to be as high as is achievable, thus operating with measurements that have relatively little error. However, to use such a vector m the traditional approach of distorting the projected line segments reduces the operable range significantly.

In some cases, a transformation matrix P is defined that can create a distortion of the projected lattice, but less distortion than going to a subset of a hypercubic lattice. The distortion can then be more than a transformation giving no distortion, but less than a transformation giving a subset of the hypercubic lattice. In some examples, there are computational advantages to such a middle ground approach. In terms of computational cost and unwrapping error probability, the middle-ground approach is in between a transformation giving a hypercubic lattice subset and a transformation that doesn't distort the lattice. For instance, for the example of measurements at M=3 frequencies, in some implementations, a transformation to a subset of a hexagonal lattice allows for fast unwrapping that is approximate but gives less error than projecting to a subset of a hypercubic lattice, while allowing for more efficient unwrapping than a transformation giving no distortion.

What is desirable is therefore a device and method that can accurately unwrap, while at the same time being computationally efficient. Systems and methods for accurate computationally efficient unwrapping are presented herein.

For a given set of points {p₁, . . . , p_{N}} in an (M−1) dimensional space, the set of points nearest to a given point pᵢ than to any of the points pⱼ (not including pᵢ) is called the Voronoi cell of pᵢ. For example, in FIG. 1B the Voronoi cell of point 130 is enclosed by the perimeter 132. The Voronoi cell is delimited by subsets of a finite number of (M−2) dimensional hyperplanes. For example, for M=3, in FIG. 1B the perimeter 132 of the Voronoi cell is made up of (M−2) dimensional hyperplanes, which are line segments. The Voronoi cell may be characterized by a minimal set of vectors {v₁, . . . , v_{L}} and the center O of the cell, such that a point p is in the Voronoi cell if it satisfies

$$p . {v}_{i} < \frac{1}{2} {v}_{i} . {v}_{i}$$

for all i in {1, . . . , L}. In some examples, the point p is in the Voronoi cell only if it satisfies

$$p . {v}_{i} < \frac{1}{2} {v}_{i} . {v}_{i}$$

for all i in {1, . . . , L}. The vectors {v₁, . . . , v_{L}} that define the Voronoi cell are thus chosen so that the hyperplanes that delineate the Voronoi cell are subsets of the planes that bisect the vectors {v₁, . . . , v_{L}}.

If the vector m of ratios of frequencies is made up of integers, and {p₁, . . . , p_{N}} is the set of projected line segments, then {p₁, . . . , p_{N}} will be a subset of a regular lattice. An approximate nearest neighbor of a given projected point q can be found as follows: a set {w₁, w_{M-1}} of M−1 dimensional vectors can be defined which span the lattice that {p₁, . . . , p_{N}} is a subset of. A given projected point q can be decomposed as a sum of the vectors wᵢ, writing q=Σᵢ₌₁^{M-1}λᵢwᵢ. A projection matrix P can be defined which takes a vector v of phases, and outputs the vector (λ₁, . . . , λ_{M-1}) of coordinates of the projection q of v orthogonal to m. The vector of nearest integers ([λ₁], . . . , [λ_{M-1}]) to the λᵢ provides a point wₛₜₐᵣₜ=Σᵢ₌₁^{M-1}[λᵢ]wᵢ on the lattice that {pᵢ, . . . , p_{N}} is a subset of. In some examples, the point wₛₜₐᵣₜ is the projected line segment nearest to q, in which case unwrapping was successful. However, in other examples, the point wₛₜₐᵣₜ is not the nearest projected line segment to q.

The projected line segment nearest to q is a neighbor of wₛₜₐᵣₜ·wₛₜₐᵣₜ can be refined in a computationally efficient manner to give the true nearest neighbor of q. Calculating

$$\frac{( q - {w}_{start} ) . {v}_{i}}{{v}_{i} . {v}_{i}}$$

over the set of vectors {v₁, . . . , v_{L}} that characterize the Voronoi cell, where v·w denotes the inner product between two vectors v and w, the vector vᵢ that maximizes

$$\frac{( q - {w}_{start} ) . {v}_{i}}{{v}_{i} . {v}_{i}}$$

is added to wₛₜₐᵣₜ. This process is repeated until (q−wₛₜₐᵣₜ) is in the Voronoi cell around the origin.

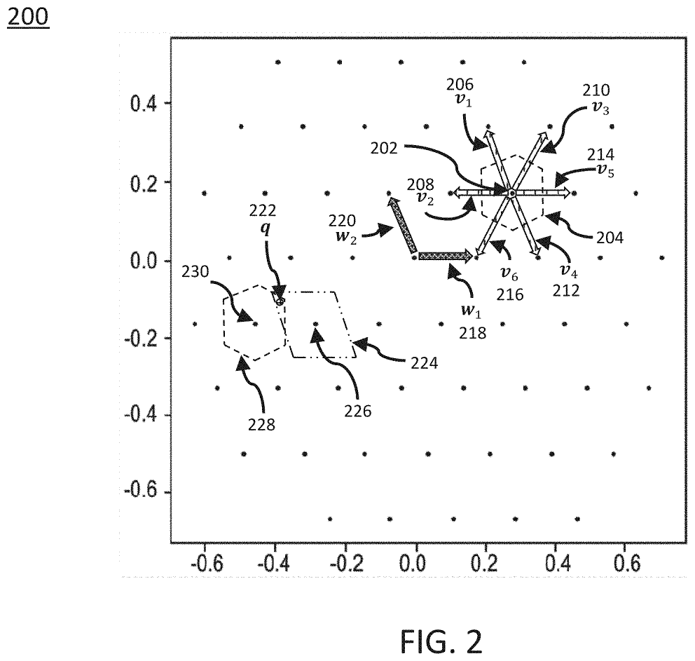

FIG. 2 shows a diagram of a lattice for phase unwrapping, according to various embodiments of the disclosure. FIG. 2 shows examples of the different entities involved in various implementations of accurate fast phase unwrapping. In particular, FIG. 2 shows entities involved in phase unwrapping for measurements at three different frequencies (M=3). A projected line segment 202 has a Voronoi cell delineated by a perimeter 204, such that all points inside the Voronoi cell are closer to the projected line segment 202 than to any other projected line segment. The vectors v₁ 206, v₂ 208, v₃ 210, v₄ 212, v₅ 214, and v₆ 216, define the Voronoi cell, by stipulating that a point p is in the Voronoi of point 202 if

$$\frac{p . {v}_{i}}{{v}_{i} . {v}_{i}} < \frac{1}{2}$$

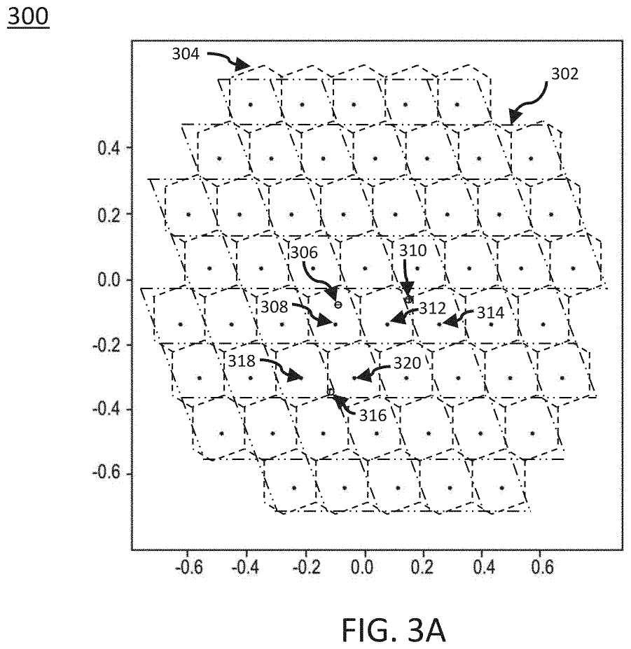

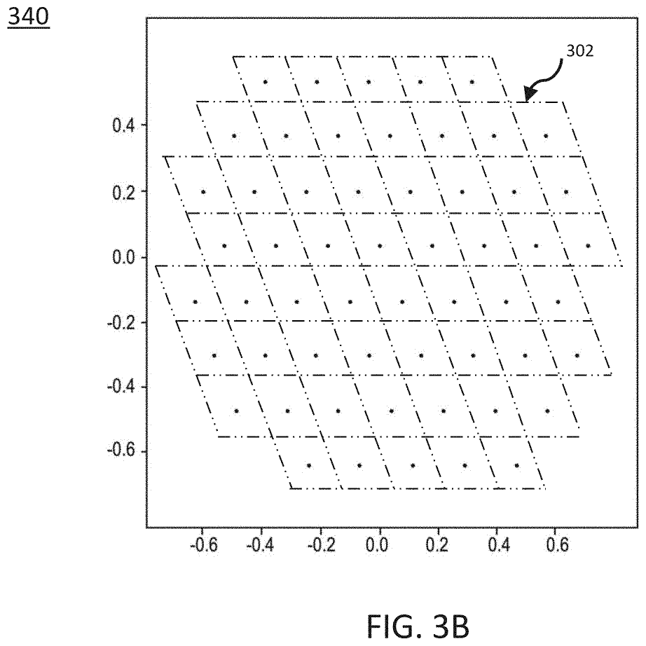

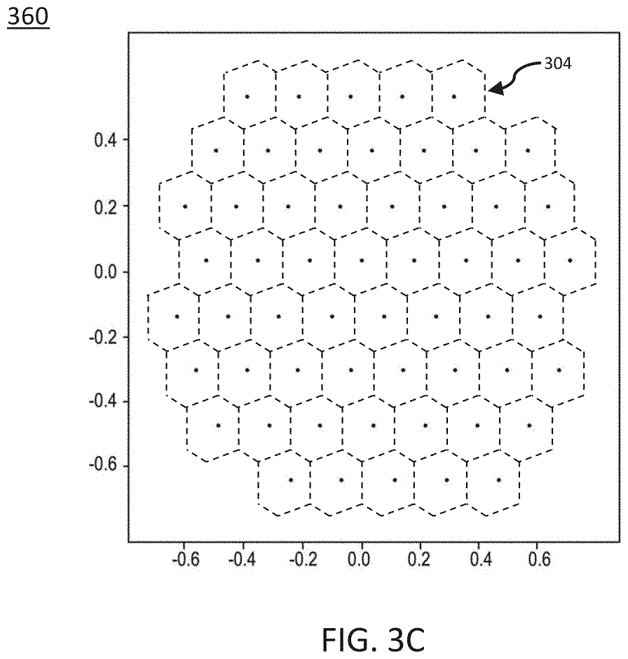

for i=1, 2, 3, 4, 5 and 6. In some examples, the vectors v₁ 206, v₂ 208, v₃ 210, v₄ 212, v₅ 214, v₆ 216, are referred to as Voronoi vectors. The vectors w₁ 218 and w₂ 220 span a lattice that contains all the projected line segments (such as the lattice shown in FIG. 3C). A projected measurement vector q 222 is inside the Voronoi cell of point 230, delineated by perimeter 228. Therefore point 230 may be the most likely unwrapping line segment associated with the projected measurement 222.

A fast approach to finding the point 230 starting with point q 222 is to apply a transformation that decomposes q in terms of vectors w₁ and w₂: q=λ₁w₁+λ₂ w₂. In the example in FIG. 2, λ₁=−2.3, λ₂=−0.7. The starting projected line segment is then wₙₑₐᵣₑₛₜ=[λ₁]w₁=[λ₂]w₂=−2w₁−w₂. However, wₙₑₐᵣₑₛₜ=[λ₁]w₁+[λ₂]w₂=−2w₁−w₂ results in the nearest projected line segment represented by the point 226. The points inside the perimeter 224 have the same initial wₙₑₐᵣₑₛₜ=−2w₁−w₂.

Using the Voronoi cell approach described above, the vᵢ vector that maximizes

$$\frac{( q - {w}_{start} ) . {v}_{i}}{{v}_{i} . {v}_{i}}$$

in this example is v₂, which is added to wₛₜₐᵣₜ to give wₛₜₐᵣₜ=−2w₁−w₂+v₂=−3w₁−w₂, where the relation w₁=−v₂ that holds in this exemplary embodiment was used. Thus, the point q 222 is in the Voronoi cell 228 of point 230 using wₛₜₐᵣₜ=−3w₁−w₂. Therefore, the most likely unwrapping point, the point 230, can be identified with efficient processing. In this embodiment, the initially estimated nearest project line segment wₛₜₐᵣₜ is at most one vector vᵢ away from the most likely unwrapping projected line segment, and therefore the amount of computation for each pixel is bounded.

FIG. 3A is a diagram showing lattices for phase unwrapping, according to various embodiments of the disclosure. The lattices shown in FIG. 3A can be used for fast and accurate phase unwrapping in time-of-flight systems having three measurement frequencies (M=3). As described above, projected measurement points q can be decomposed in a basis of vectors {w₁, . . . , w_{M-1}} that span the lattice: q=Σᵢ₌₁^{M-1}λᵢwᵢ. A starting vector wₛₜₐᵣₜ=Σᵢ₌₁^{M-1}[λᵢ]wᵢ is then obtained. For three measurements (M=3), the points for which the starting vector wₛₜₐᵣₜ is the same form a parallelogram. The set of parallelograms form a lattice 302. Each projected measurement point is inside a parallelogram, which contains one starting projected line segment wₛₜₐᵣₜ Exemplary point 306 is inside a parallelogram that includes a starting projected line segment wₛₜₐᵣₜ 308. FIG. 3B is a diagram showing the parallelogram lattice 302 for phase unwrapping, according to various embodiments of the disclosure.

Each point in FIG. 3A is also part of a Voronoi cell, as also illustrated in FIG. 3C. In particular, FIG. 3C is a diagram showing the Voronoi cell lattice for phase unwrapping, according to various embodiments of the disclosure. The Voronoi cells form a lattice 304. The points inside a Voronoi cell are closer to the projected line segment than to any other projected line segment.

Referring to FIG. 3A, since the point 306 is inside the Voronoi cell of starting projected line segment 308, the correct unwrapping was found by finding wₛₜₐᵣₜ The exemplary point 310, however, is inside the parallelogram of point 314, but it is inside the Voronoi cell of point 312. Therefore, for the point 310, one step of adding a vector characterizing the Voronoi cell to wₛₜₐᵣₜ is taken to reach point 312. Similarly, the exemplary point 316 is in inside the parallelogram of point 318, but it is inside the Voronoi cell of point 320. One step of adding a vector to wₛₜₐᵣₜ is taken to identify the mapping of the measurement point 316 as the point 320 (whose Voronoi cell the measurement point 316 is inside of) as opposed to the point 318.

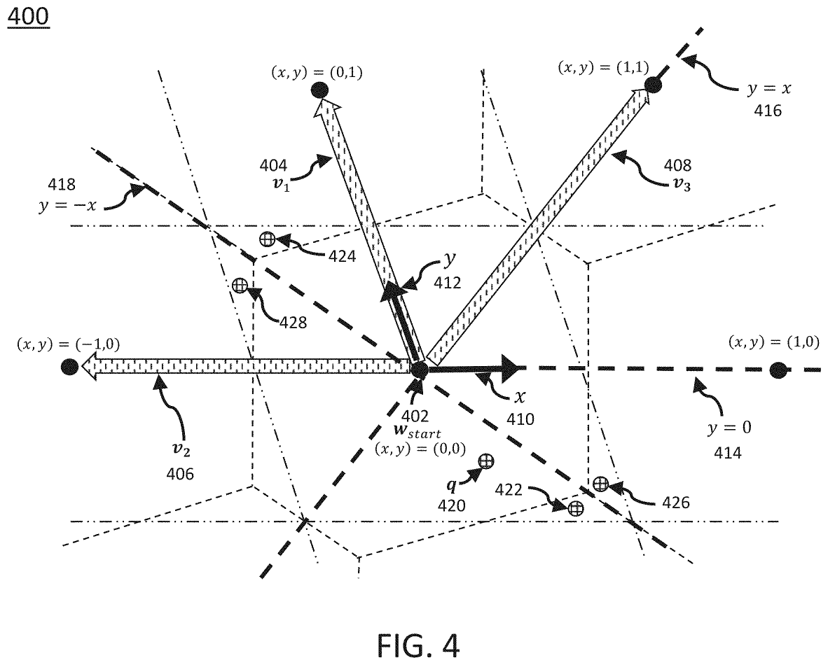

In some implementations, the computations used to reach the projected line segment whose Voronoi cell includes a given projected measurement point can be further simplified. FIG. 4 illustrates further simplification of measurements, according to various embodiments of the disclosure. In particular, FIG. 4 shows a diagram identifying a projected line segment associated with a measurement point for a case with three measurements (M=3). Point 402 is a projected line segment. Any projected set of measurements that lands in the parallelogram around the point 402 will have wₛₜₐᵣₜ be point 402. Points 420, 422, 424 are exemplary points in the parallelogram of 402. A coordinate system with axis x 410 and axis y 412 can be defined with an origin (where x=0 and y=0) at the point 402. The coordinate axes x and y can be normalized so that at the lattice points x and y are integers. Given the coordinates (x_{q}, y_{q}) of a projected measurement vector q, the nearest lattice point to q can be found using the following logic.

If x_{q}>−y_{q} then

If

$$\frac{{v}_{1} . ( {x}_{q} , {y}_{q} )}{{v}_{1} . {v}_{1}} > 1 / 2$$

add v₁ to wₛₜₐᵣₜ

Else if

$$\frac{{v}_{2} . ( {x}_{q} , {y}_{q} )}{{v}_{2} . {v}_{2}} < - 1 / 2$$

add −v₂ to wₛₜₐᵣₜ

If x_{q}≤−y_{q} then

If

$$\frac{{v}_{2} . ( {x}_{q} , {y}_{q} )}{{v}_{2} . {v}_{2}} > 1 / 2$$

add v₂ to wₛₜₐᵣₜ

Else if

$$\frac{{v}_{1} . ( {x}_{q} , {y}_{q} )}{{v}_{1} . {v}_{1}} < - \frac{1}{2}$$

add −v₁ to wₛₜₐᵣₜ

In various examples, the inner products v₁·v₁ and v₂·v₂ are precomputed and stored. According to some examples, the inner products v₁·u and v₂·u (where u represents (x_{q}, y_{q})) are computed as measurements are received. Therefore, by precomputing the inner products v₁·v₁ and v₂·v₂, the refinement step for wₛₜₐᵣₜ is computationally extremely efficient. Referring to FIG. 4, case a.(i) is exemplified by the point 424. The case a.(ii) is exemplified by the point 426. The case b.(i) is exemplified by the point 428. The case b.(ii) is exemplified by the point 422. If a point q satisfies none of the criteria for the four cases, as exemplified by the point 420, then q is already in the Voronoi cell of wₛₜₐᵣₜ

In any dimension M, the maximum number of addition of vectors vᵢ to the initial wₛₜₐᵣₜ can be determined beforehand. Therefore, a processor will know beforehand how much processing power is used to run accurate unwrapping on all pixels. The cases that are determined to decide how to add vectors to wₛₜₐᵣₜ can also be computed in advance.

In various examples described herein, three frequencies are used for the phase unwrapping in ToF imaging. In other examples, more frequencies are used, resulting in better accuracy and higher dimensions. In particular, using more frequencies can result in better unwrapping with fewer mistakes.

In various implementations, any multiplications of the base frequency can be used for the various phases. In one example, 17, 19, and 22 are used such that the phases are measured at 17 times the base frequency, 19 times the base frequency, and 22 times the base frequency. In some examples, the base frequency is 20 megahertz or 25 megahertz, and the base frequency can be any selected frequency. Note that a higher frequency results in more measurement points.

### SELECT EXAMPLES

Example 1 provides a method for phase unwrapping in time-of-flight systems comprising determining a plurality of wrapped distance measurements at a respective plurality of frequencies, wherein each of the plurality of wrapped distance measurements corresponds to a respective phase; generating a plurality of unwrapped depths for each of the plurality of wrapped distance measurements, based on the respective phase; measuring a plurality of Voronoi vectors corresponding to the plurality of unwrapped depths; and determining a lattice of Voronoi cells, wherein each of the plurality of unwrapped depths corresponds to a respective Voronoi cell of the lattice.

Example 2 provides a method according to one or more of the preceding and/or following examples, further comprising estimating a distance to an object, and identifying a corresponding Voronoi cell of the lattice for the estimated distance.

Example 3 provides a method according to one or more of the preceding and/or following examples wherein identifying the corresponding Voronoi cell includes using a lookup table to map the estimated distance to the corresponding Voronoi cell.

Example 4 provides a method according to one or more of the preceding and/or following examples, further comprising applying a transformation to the estimated distance using a plurality of vectors.

Example 5 provides a method according to one or more of the preceding and/or following examples, further comprising generating a plurality of projected line segment points wherein each of the plurality of projected line segment points corresponds with a respective one of the plurality of unwrapped depths.

Example 6 provides a method according to one or more of the preceding and/or following examples wherein determining the lattice of Voronoi cells includes determining an area around each of the plurality of projected line segment points corresponding with the respective projected line segment point based on the plurality of Voronoi vectors.

Example 7 provides a method according to one or more of the preceding and/or following examples wherein each of the plurality of frequencies is a multiple of a base frequency.

Example 8 provides a method according to one or more of the preceding and/or following examples wherein the plurality of frequencies includes a first frequency at seventeen times the base frequency, a second frequency at nineteen times the base frequency, and a third frequency at twenty-two times the base frequency.

Example 9 provides a system for phase-unwrapping comprising a receiver configured to receive reflected frequencies and a processor. The processor is configured to determine a plurality of wrapped distance measurements at a respective plurality of frequencies, wherein each of the plurality of wrapped distance measurements corresponds to a respective phase, generate a plurality of projected line segment points based on the plurality of wrapped distance measurements, and determine a lattice of Voronoi cells, wherein each Voronoi cell corresponds to one of the plurality of projected line segment points.

Example 10 provides a system according to one or more of the preceding and/or following examples wherein the processor is further configured to measure a plurality of Voronoi vectors, and wherein an area for each Voronoi cell of the lattice is determined based on Voronoi vectors.

Example 11 provides a system according to one or more of the preceding and/or following examples wherein the processor is further configured to measure a distance to an object and identify a corresponding Voronoi cell of the lattice for the measured distance.

Example 12 provides a system according to one or more of the preceding and/or following examples wherein the processor is further configured to measure the distance based on the received reflected frequencies.

Example 13 provides a system according to one or more of the preceding and/or following examples wherein the processor is further configured to generate a plurality of unwrapped depths for each of the plurality of wrapped distance measurements, based on the respective phase, and wherein each of the plurality of projected line segment points corresponds with a respective one of the plurality of unwrapped depths.

Example 14 provides a system according to one or more of the preceding and/or following examples further comprising an emitter configured to emit a plurality of frequencies and wherein at least a portion of the plurality of frequencies reflected and received at the receiver.

Example 15 provides a system according to one or more of the preceding and/or following examples wherein each of the plurality of frequencies emitted by the emitter is a multiple of a base frequency.

Example 16 provides a system according to one or more of the preceding and/or following examples wherein the plurality of frequencies emitted by the emitter includes a first frequency at seventeen times the base frequency, a second frequency at nineteen times the base frequency, and a third frequency at twenty-two times the base frequency.

Example 17 provides a method for phase unwrapping in time-of-flight systems, comprising estimating a distance to an object and generating a corresponding measurement point; applying a transformation to the measurement point using a plurality of vectors; matching the measurement point to a Voronoi cell for a wrapped distance measurement based on the transformation, wherein the wrapped distance measurement is a projected line segment point; and determining an unwrapped depth based on the projected line segment point.

Example 18 provides a method according to one or more of the preceding and/or following examples wherein applying the transformation includes using Voronoi vectors to identify the Voronoi cell.

Example 19 provides a method according to one or more of the preceding and/or following examples wherein the measurement point is at most one Voronoi vector away from the projected line segment point.

Example 20 provides a method according to one or more of the preceding and/or following examples wherein the measurement point includes a first measurement at a first frequency, a second measurement at a second frequency, and a third measurement at a third frequency.

Example 21 provides a system for phase unwrapping, comprising a transmitter configured to transmit a plurality of frequencies, wherein the plurality of frequencies include a first frequency at seventeen times the base frequency, a second frequency at nineteen times the base frequency, and a third frequency at twenty-two times the base frequency; a receiver configured to receive a plurality of reflected frequencies corresponding to the plurality of frequencies; and a processor configured to determine a plurality of wrapped distance measurements at the plurality of frequencies and determine a lattice of Voronoi cells wherein each Voronoi cell corresponds to a respective wrapped distance measurement.

Example 22 provides a system according to one or more of the preceding and/or following examples wherein each of the plurality of wrapped distance measurements corresponds to a respective phase.

Example 23 provides a system according to one or more of the preceding and/or following examples wherein the processor is further configured to measure a plurality of Voronoi vectors, and wherein an area for each Voronoi cell of the lattice is determined based on Voronoi vectors.

Example 24 provides a system according to one or more of the preceding and/or following examples wherein the processor is further configured to measure a distance to an object based on a subset of the plurality of reflected frequencies and identify a corresponding Voronoi cell of the lattice for the measured distance.

Example 25 provides a system according to one or more of the preceding and/or following examples wherein the measured distance corresponds to a measurement point.

Example 26 provides a system according to one or more of the preceding and/or following examples wherein the processor is further configured to apply a transformation to the measurement point using a plurality of vectors.

Example 27 provides a system according to one or more of the preceding and/or following examples, wherein the plurality of vectors include Voronoi vectors.

Example 28 provides a system according to one or more of the preceding and/or following examples wherein the processor is further configured to apply a transformation to the measurement point to identify the corresponding Voronoi cell.

### Variations and Implementations

Applicant has recognized and appreciated that distance sensing may be performed by an imaging device with a higher power efficiency by emitting illumination light in only some, not all, cases in which a distance determination is desired. In those cases, in which illumination light is not emitted by the device, image analysis techniques may be used to estimate distances by comparing 2D images captured by the imaging device and detecting how an object or objects in those images change over time.

According to some embodiments, distances previously determined when illumination light was produced and captured may be used as a reference to aid in estimation of distance using 2D image analysis techniques. For example, illumination light may be emitted periodically to periodically determine distances, and in between those emissions image analysis may be performed to determine distances (e.g., using the previously-determined distances obtained using illumination light as a reference point).

According to some embodiments, a decision of whether to emit illumination light (to determine distances by collecting the reflected illumination light) may be based on an analysis of 2D images. The analysis may determine how accurate an estimation of distance will be based on one or more 2D images, so that when the accuracy falls below an acceptable threshold, a decision may be made to obtain a more accurate determination of distance using illumination light. In this manner, illumination light may be emitted only when a 2D image analysis does not produce acceptably accurate distance measurements, which may reduce the frequency with which the illumination light is emitted, thereby reducing power usage.

While aspects of the present disclosure may be used in any suitable imaging device, there may be particular advantages to applying such aspects within imaging devices that capture light during a plurality of frames, such as in video capture. Some imaging devices may be configured to ultimately preserve a single image yet may capture images a number of times prior to and/or after the image device has been activated to preserve the single image (e.g., devices configured to display a scene prior to capture of a single image for purposes of previewing the still image, and/or devices configured to capture a plurality of images when activated to capture a single image so that a single image can be selected and/or synthesized from the plurality of images). For the purposes of the discussion herein, a “frame” is considered to be applicable to both image capture during: (i) video capture; and (ii) still image capture where multiple images are registered in a device during the still image capture process (including, but not limited to, those examples above).

According to some embodiments, determining whether to emit illumination light based on an analysis of a 2D image may be performed in the same frame during which the 2D image was captured. Making the determination within the same frame may ensure that, in the case it is determined that illumination light is not to be emitted, a 2D image may be captured during the subsequent frame without there being an interim frame in which the determination is be made. Accordingly, the imaging device may operate efficiently by capturing an image during each frame. According to some embodiments, once it is determined that illumination light is to be emitted, the illumination light is emitted during the same frame during which the determination was made. Alternatively, if there is insufficient time during a frame to capture a 2D image, determine whether to emit illumination light and also emit the illumination light (e.g., because the imaging device does not have the processing capacity to perform all these steps within the frame because the frame time is very short and/or due to processing limitations of the device), the emission of illumination light may occur in a subsequent frame.

Following below are more detailed descriptions of various concepts related to, and embodiments of, techniques of distance sensing. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

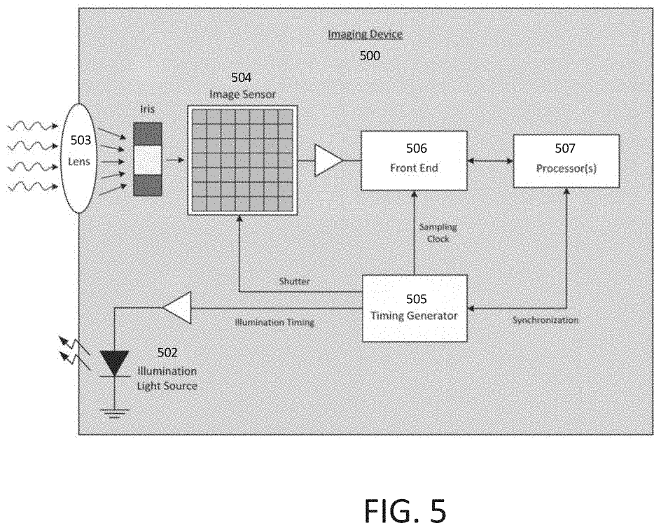

FIG. 5 shows the components in an exemplary imaging device 500 capable of forming an image of the distance to objects in the scene, according to various aspects of the invention. An illumination light source 502 emits light, which reflects off objects in the scene. In some examples, the light frequency is an infrared frequency to reduce the contribution from sunlight. Some of the reflected light enters the lens 503 in front of the image sensor 504. A timing generator 505 sends signals to the light source which controls the amount of light being emitted. The timing generator 505 also sends signals to the image sensor 504. The signals to the image sensor 504 from the timing generator 505 are used to determine the sensitivity of the image sensor 504. The sensitivity of the image sensor 504 dictates how much charge the sensor 504 generates per unit of incoming light. In particular, the sensor 504 has a set of charge storage units at each pixel and as it collects signal it can add that signal to one of its storage units. A front end 506 reads out the contents of each storage unit and converts them to a number. A processor 507 performs the computations on the storage units that lead to a distance measurement at each pixel.

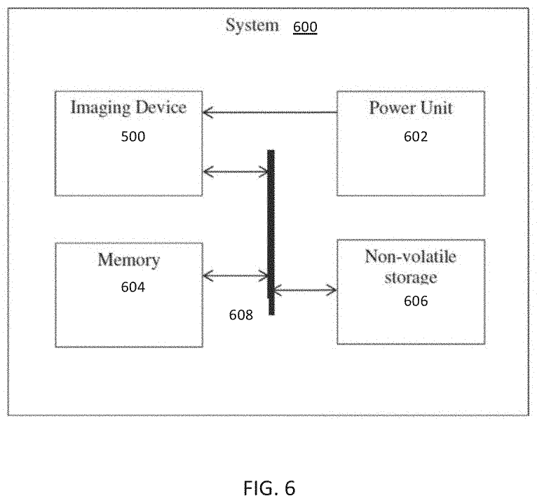

FIG. 6 illustrates an example of system incorporating an imaging device of the type described herein. An illustrative implementation of a system 600 which may incorporate an imaging device of the types described herein and shown in FIG. 5. The system 600 includes the imaging device 500 of FIG. 5, although imaging devices according to alternative embodiments described herein may alternatively be included. A power unit 602 may be provided to power the imaging device 500, along with potentially power other components of the system. The power unit 602 may be a battery in some embodiments, such as a battery typically used in mobile phones, tablets, and other consumer electronics products. As has been described, in some embodiments the imaging device 500 may provide low power operation, and thus may facilitate the use of a low power battery as the power unit 602. However, the power unit 602 is not limited to being a battery, nor is it limited to a particular type of battery in all embodiments.

The system 600 further comprises a memory 604 and a non-volatile storage 606. Those components may be communicatively coupled to the imaging device 500 in any suitable manner, such as via a shared communication link 608. The shared communication link 608 may be a bus or other suitable connection. The memory 604 and/or non-volatile storage 606 may store processor-executable instructions for controlling operation of the imaging device 500, and/or data captured by the imaging device 500. In connection with techniques for distance sensing as described herein, code used to, for example, signal an illumination light source to produce one or more light pulses, to open and/or close a shutter of an image sensor, read out pixels of an image sensor, perform distance calculations based on collected illumination light, etc. may be stored on one or more of memory 604 or non-volatile storage 606. Processor 507 may execute any such code to provide any techniques for distance sensing as described herein. Memory 604 may store data representative of 2D and/or 3D images captured by imaging device 500. The memory 604 and/or non-volatile storage 606 may be non-transitory memory in at least some embodiments.

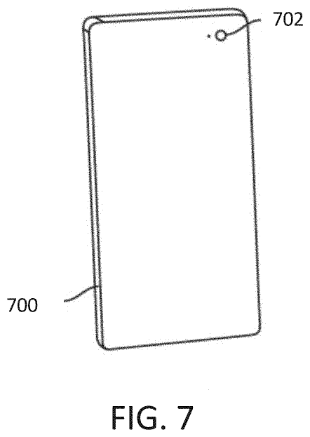

The imaging systems described herein may be used in various applications, some examples of which are described in connection with FIGS. 7-9. A first example is that of a mobile device, such as a smartphone, tablet computer, smartwatch, or other mobile device. The imaging systems of the type described herein, such as the imaging device 500 or system 700, may be used as a camera component of the mobile device. FIG. 7 illustrates a mobile device 700 incorporating an imaging device of the types described herein.

The mobile phone 700 includes a camera 702 which may be an imaging device of the types described herein for capturing and generating 3D images, such as imaging device 500. The use of imaging device 500 as camera 702 may be facilitated by low power consumption operation, such as the manners of operation described herein in connection with the imaging devices according to aspects of the present application. Mobile devices, such as mobile phone 700, typically operate from battery power, and thus components which consume substantial power can be impractical for use within such devices. Imaging devices of the types described herein, by contrast, may be deployed within such devices in a power efficient manner.

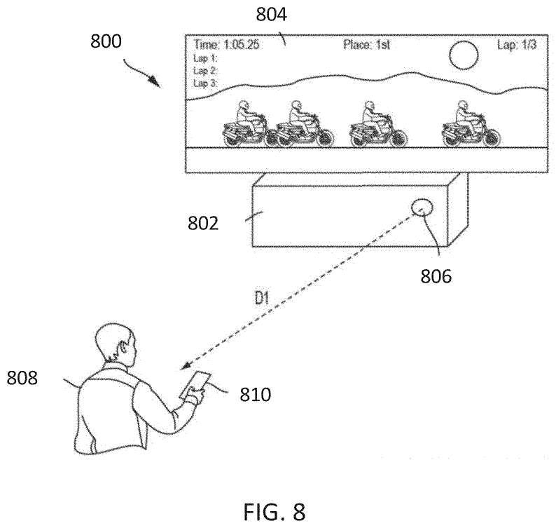

FIG. 8 illustrates an entertainment system 800 implementing an imaging system of the types described herein. The entertainment system 800 includes a console 802 and display 804. The console may be a video gaming console configured to generate images of a video game on the display 804, and may include a camera 806. The camera 806 may be an imaging system of the types described herein configured to capture 3D images, such as imaging device 500. In the example of FIG. 8, a user 808 may interact with the entertainment system via a controller 810, for example to play a video game. The camera 806 may capture images of the user and/or controller, and may determine a distance D1 to the user. The distance information may be used to generate a 3D image for display on the display 804 or for control of some other aspect of the entertainment system. For example, the user 802 may control the entertainment system with hand gestures, and the gestures may be determined at least in part through capturing distance information D1.

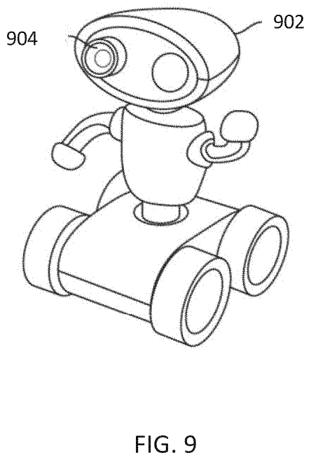

Imaging systems of the types described herein may also be employed in robotics. FIG. 9 illustrates an example of a robot 902 with an imaging system 904. The robot may be mobile and the information collected by imaging system 904 may be used to assist in navigation and/or motor control of the robot. The imaging system 904 may be of the types described herein, for example being the system or imaging device 500. Mobile robots are typically powered by batteries, and thus imaging systems of the types described herein which may operate at relatively low power according to at least some of the described embodiments may facilitate their integration with the robot.

Examples of uses of the technology described herein beyond those shown in FIGS. 7-9 are also possible. For example, automobiles and security cameras may implement 3D imaging devices of the types described herein.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present disclosure.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

Note that the activities discussed above with reference to the FIGURES which are applicable to any integrated circuit that involves signal processing (for example, gesture signal processing, video signal processing, audio signal processing, analog-to-digital conversion, digital-to-analog conversion), particularly those that can execute specialized software programs or algorithms, some of which may be associated with processing digitized real-time data.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC, IP block, or SoC), a non-transitory medium could include a hardware device hardware-programmed with logic to perform the methods or functions disclosed herein. The teachings could also be practiced in the form of Register Transfer Level (RTL) or other hardware description language such as VHDL or Verilog, which can be used to program a fabrication process to produce the hardware elements disclosed.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, processors may store information in any suitable type of non-transitory storage medium (for example, random access memory (RAM), read only memory (ROM), FPGA, EPROM, electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Computer program logic implementing all or part of the functionality described herein is embodied in various forms, including, but in no way limited to, a source code form, a computer executable form, a hardware description form, and various intermediate forms (for example, mask works, or forms generated by an assembler, compiler, linker, or locator). In an example, source code includes a series of computer program instructions implemented in various programming languages, such as an object code, an assembly language, or a high-level language such as OpenCL, RTL, Verilog, VHDL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In some embodiments, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc.

Other components such as external storage, additional sensors, controllers for audio/video display, and peripheral devices may be attached to the board as plug-in cards, via cables, or integrated into the board itself. In another example embodiment, the electrical circuits of the FIGURES may be implemented as standalone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this disclosure.

In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Interpretation of Terms

All definitions, as defined and used herein, should be understood to control over dictionary definitions, definitions in documents incorporated by reference, and/or ordinary meanings of the defined terms. Unless the context clearly requires otherwise, throughout the description and the claims:

“comprise,” “comprising,” and the like are to be construed in an inclusive sense, as opposed to an exclusive or exhaustive sense; that is to say, in the sense of “including, but not limited to”.

“connected,” “coupled,” or any variant thereof, means any connection or coupling, either direct or indirect, between two or more elements; the coupling or connection between the elements can be physical, logical, or a combination thereof.

“herein,” “above,” “below,” and words of similar import, when used to describe this specification shall refer to this specification as a whole and not to any particular portions of this specification.

“or,” in reference to a list of two or more items, covers all of the following interpretations of the word: any of the items in the list, all of the items in the list, and any combination of the items in the list.

the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke 35 U.S.C. § 112(f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

1. A method for phase unwrapping in time-of-flight systems, comprising:
determining a plurality of wrapped distance measurements at a respective plurality of frequencies, wherein each of the plurality of wrapped distance measurements corresponds to a respective phase;
generating a plurality of unwrapped depths for each of the plurality of wrapped distance measurements, based on the respective phase;
measuring a plurality of Voronoi vectors corresponding to the plurality of unwrapped depths; and
determining a lattice of Voronoi cells, wherein each of the plurality of unwrapped depths corresponds to a respective Voronoi cell of the lattice.

2. The method of claim 1, further comprising measuring a distance to an object, and identifying a corresponding Voronoi cell of the lattice for the measured distance.

3. The method of claim 2, wherein identifying the corresponding Voronoi cell includes using a lookup table to map the distance to the corresponding Voronoi cell.

4. The method of claim 2, further comprising applying a transformation to the distance using a plurality of vectors.

5. The method of claim 1, further comprising generating a plurality of projected line segment points wherein each of the plurality of projected line segment points corresponds with a respective one of the plurality of unwrapped depths.

6. The method of claim 5, wherein determining the lattice of Voronoi cells includes determining an area around each of the plurality of projected line segment points corresponding with the respective projected line segment point based on the plurality of Voronoi vectors.

7. The method of claim 1, wherein each of the plurality of frequencies is a multiple of a base frequency.

8. The method of claim 7, wherein the plurality of frequencies includes a first frequency at seventeen times the base frequency, a second frequency at nineteen times the base frequency, and a third frequency at twenty-two times the base frequency.

9. A system for phase unwrapping, comprising:
a receiver configured to receive reflected frequencies; and
a processor configured to:
determine a plurality of wrapped distance measurements at a respective plurality of frequencies, wherein each of the plurality of wrapped distance measurements corresponds to a respective phase,
generate a plurality of projected line segment points based on the plurality of wrapped distance measurements, and
determine a lattice of Voronoi cells, wherein each Voronoi cell corresponds to one of the plurality of projected line segment points.

10. The system of claim 9, wherein the processor is further configured to measure a plurality of Voronoi vectors, and wherein an area for each Voronoi cell of the lattice is determined based on Voronoi vectors.

11. The system of claim 9, wherein the processor is further configured to measure a distance to an object and identify a corresponding Voronoi cell of the lattice for the measured distance.

12. The system of claim 11, wherein the processor is further configured to measure the distance based on the received reflected frequencies.

13. The system of claim 9, wherein the processor is further configured to generate a plurality of unwrapped depths for each of the plurality of wrapped distance measurements, based on the respective phase, and wherein each of the plurality of projected line segment points corresponds with a respective one of the plurality of unwrapped depths.

14. The system of claim 9, further comprising an emitter configured to emit a plurality of frequencies and wherein at least a portion of the plurality of frequencies reflected and received at the receiver.

15. The system of claim 14, wherein each of the plurality of frequencies emitted by the emitter is a multiple of a base frequency.

16. The system of claim 15, wherein the plurality of frequencies emitted by the emitter includes a first frequency at seventeen times the base frequency, a second frequency at nineteen times the base frequency, and a third frequency at twenty-two times the base frequency.

17. A method for phase unwrapping in time-of-flight systems, comprising:
estimating a distance to an object and generating a corresponding measurement point;
applying a transformation to the measurement point using a plurality of vectors;
matching the measurement point to a Voronoi cell for a wrapped distance measurement based on the transformation, wherein the wrapped distance measurement is a projected line segment point; and
determining an unwrapped depth based on the projected line segment point.

18. The method of claim 17, wherein applying the transformation includes using Voronoi vectors to identify the Voronoi cell.

19. The method of claim 18, wherein the measurement point is at most one Voronoi vector away from the projected line segment point.

20. The method of claim 17, wherein the measurement point includes a first measurement at a first frequency, a second measurement at a second frequency, and a third measurement at a third frequency.
